(19) United States
(12) Patent Application Publication
(10) Pub. No.: US 2025/0239422 A1
(43) Pub. Date: Jul. 24, 2025

(54) KEY SWITCH ASSEMBLY AND METHOD OF USING THE SAME

(71) Applicant: HONEYWELL INTERNATIONAL INC., Charlotte, NC (US)

(72) Inventors: Gangaraju B, Charlotte, NC (US); Deviprasad J SHETTIGAR, Charlotte, NC (US); Arul A, Charlotte, NC (US); Basavaraja M TELI, Charlotte, NC (US); Ranjit NAIR, Charlotte, NC (US)

(21) Appl. No.: 19/008,917

(22) Filed: Jan. 3, 2025

(30) Foreign Application Priority Data
Jan. 22, 2024 (IN) 202411004305

(51) Int. Cl. H01H 9/04

(52) U.S. Cl. CPC H01H 9/04

(57) ABSTRACT

A key switch assembly and method of using the same. In various embodiments, a key switch assembly may comprise a key cylinder assembly comprising a key cylinder housing; a terminal contact assembly comprising a terminal contact housing, the terminal contact assembly being configured for attachment to the key cylinder assembly via an engagement of the terminal contact housing with the key cylinder housing, the being defined by one or more positive snap connection at which a first snap feature of the terminal contact housing is physically engaged with a corresponding second snap feature of the key cylinder housing; wherein the one or more positive snap connection is defined within an internal chamber of the key switch assembly such that the each positive snap connection is physically inaccessible from an exterior of the key switch assembly when the key switch assembly is in an assembled configuration.

### CROSS-REFERENCE TO RELATED APPLICATIONS

This application claims priority pursuant to 35 U.S.C. 119(a) to Indian Application No. 202411004305, filed Jan. 22, 2024, which application is incorporated herein by reference in its entirety.

### FIELD OF THE INVENTION

Various embodiments described herein relate generally to key switch assemblies, and more particularly, to tamper-proof key switch assemblies configured for mitigating undesirable effects of wear resulting from use throughout lifespan of the key switch assembly.

### BACKGROUND

Applicant has identified many technical challenges and difficulties associated with conventional key switch assemblies, including key switch assemblies defined by a terminal contact assembly and a key cylinder assembly that are assembled together as a singular unit. Through applied effort, ingenuity, and innovation, Applicant has solved problems related to these key switch assemblies by developing solutions embodied in the present disclosure, which are described in detail below.

### BRIEF SUMMARY

Various embodiments are directed to a key switch assembly and method of using the same. In various embodiments, a key switch assembly may comprise a key cylinder assembly comprising a key cylinder housing; a terminal contact assembly comprising a terminal contact housing, the terminal contact assembly being configured for attachment to the key cylinder assembly via one or more engagement of the terminal contact housing with the key cylinder housing, the one or more engagement being defined at least in part by one or more positive snap connection at which a first snap feature of the terminal contact housing is physically engaged with a corresponding second snap feature of the key cylinder housing to at least partially secure the terminal contact housing relative to the key cylinder housing; wherein the one or more positive snap connection is defined within an internal chamber of the key switch assembly such that the one or more positive snap connection is physically inaccessible from an exterior of the key switch assembly when the key switch assembly is in an assembled configuration.

In various embodiments, each of the one or more first snap features may comprise a male snap feature that protrudes from one or more interior surfaces defined by the terminal contact housing, and wherein each of the one or more second snap features comprises a female snap feature configured for receiving a corresponding one of the one or more first snap features to facilitate the one or more positive snap connection, wherein each of the one or more second snap features is arranged about an interior sidewall surface of the key cylinder housing. In various embodiments, the one or more positive snap connection may comprise a plurality of positive snap connections. In certain embodiments, the plurality of positive snap connections may comprise at least three positive snap connections.

In various embodiments, the at least three positive snap connections may be at least substantially evenly distributed about a central axis defined by the key cylinder housing. In various embodiments, each of the one or more second snap features may be a female snap feature comprising a pair of retention arms that each extend away from an interior sidewall surface defined by the key cylinder housing, the pair of retention arms being laterally spaced apart from one another so as to define a lateral gap therebetween within which the second snap feature is configured to receive the corresponding first snap feature of the one or more first snap features. In various embodiments, each of the one or more first snap features may be a male snap feature comprising at least one protrusion arm having a snap head provided at a distal end of the protrusion element, where each of the at least one protrusion arms protrudes from an internal base surface of the terminal contact housing in an at least substantially perpendicular direction relative to the internal base surface, each snap head being configured to facilitate a positive snap action between the first snap feature and the second snap feature. In certain embodiments, the snap head of each protrusion arm may be defined at least in part by an angled surface configured to engage at least a portion of the corresponding second snap feature and enable a movement of the first snap feature relative to the corresponding second snap feature in a connecting direction towards a locked position. In certain embodiments, the snap head of each of the two protrusions elements may define a flange that extends from a distal end of a respective shaft at an at least substantially right angle to define an engagement surface configured for physical engagement with at least a portion of the corresponding second snap feature.

In various embodiments, the one or more positive snap connections may be configured to arrange the key cylinder housing relative to the terminal contact housing such that a compression force is applied to an O-ring disposed between at least a portion of the terminal contact housing and at least a portion of the key cylinder housing, wherein the compression force is sufficiently large to cause the O-ring to embody an at least substantially air-tight seal between the at least a portion of the terminal contact housing and the at least a portion of the key cylinder housing.

Various embodiments are directed to a method comprising: providing: a key cylinder assembly comprising a key cylinder housing; a terminal contact assembly comprising a terminal contact housing, the terminal contact assembly being configured for attachment to the key cylinder assembly via one or more engagement of the terminal contact housing with the key cylinder housing; and assembling a key switch assembly by causing the one or more engagement of the terminal contact housing with the key cylinder housing, the one or more engagement being defined at least in part by one or more positive snap connection at which a first snap feature of the terminal contact housing is physically engaged with a corresponding second snap feature of the key cylinder housing to at least partially secure the terminal contact housing relative to the key cylinder housing; wherein the one or more positive snap connection is defined within an internal chamber of the key switch assembly such that the one or more positive snap connection is physically inaccessible from an exterior of the key switch assembly when the key switch assembly is in an assembled configuration.

In various embodiments, each of the one or more first snap features may comprise a male snap feature that protrudes from one or more interior surfaces defined by the terminal contact housing, and wherein each of the one or more second snap features comprises a female snap feature configured for receiving a corresponding one of the one or more first snap features to facilitate the one or more positive snap connection, wherein each of the one or more second snap features is arranged about an interior sidewall surface of the key cylinder housing. In various embodiments, the one or more positive snap connection may comprise a plurality of positive snap connections. In various embodiments, the plurality of positive snap connections may comprise at least three positive snap connections. In various embodiments, the at least three positive snap connections may be at least substantially evenly distributed about a central axis defined by the key cylinder housing. Further, In various embodiments, each of the one or more second snap features may be a female snap feature comprising a pair of retention arms that each extend away from an interior sidewall surface defined by the key cylinder housing, the pair of retention arms being laterally spaced apart from one another so as to define a lateral gap therebetween within which the second snap feature is configured to receive the corresponding first snap feature of the one or more first snap features.

In various embodiments, each of the one or more first snap features may be a male snap feature comprising at least one protrusion arm having a snap head provided at a distal end of the protrusion element, where each of the at least one protrusion arms protrudes from an internal base surface of the terminal contact housing in an at least substantially perpendicular direction relative to the internal base surface, each snap head being configured to facilitate a positive snap action between the first snap feature and the second snap feature. In certain embodiments, the snap head of each protrusion arm may be defined at least in part by an angled surface configured to engage at least a portion of the corresponding second snap feature and enable a movement of the first snap feature relative to the corresponding second snap feature in a connecting direction towards a locked position. Further, in certain embodiments, the snap head of each of the two protrusions elements may define a flange that extends from a distal end of a respective shaft at an at least substantially right angle to define an engagement surface configured for physical engagement with at least a portion of the corresponding second snap feature. In various embodiments, the one or more positive snap connections may be configured to arrange the key cylinder housing relative to the terminal contact housing such that a compression force is applied to an O-ring disposed between at least a portion of the terminal contact housing and at least a portion of the key cylinder housing, wherein the compression force is sufficiently large to cause the O-ring to embody an at least substantially air-tight seal between the at least a portion of the terminal contact housing and the at least a portion of the key cylinder housing.

### BRIEF DESCRIPTION OF THE DRAWINGS

Reference will now be made to the accompanying drawings, which are not necessarily drawn to scale, and wherein:

FIG. 1 illustrates a perspective view of an example key switch assembly in accordance with some example embodiments described herein;

FIG. 2 illustrates an isolated cutaway view of an exemplary key switch assembly in accordance with some example embodiments described herein;

FIGS. 3A and 3B illustrate a perspective full view and a perspective isolated view, respectively, of an example terminal contact housing in accordance with some example embodiments described herein;

FIG. 4 illustrates a perspective full view of an example key cylinder housing in accordance with some example embodiments described herein;

FIG. 5 illustrates an isolated cross-sectional view of an example key switch assembly in accordance with some example embodiments described herein;

FIG. 6 illustrates a cross-sectional view of various components of an example key switch assembly in accordance with some example embodiments described herein;

FIG. 7 illustrates an isolated cutaway view of an exemplary key switch assembly in accordance with some example embodiments described herein;

FIG. 8 illustrates an isolated cross-sectional view of an exemplary key switch assembly in accordance with some example embodiments described herein;

FIGS. 9A and 9B illustrate a perspective full view and a perspective isolated view, respectively, of an example key cylinder housing in accordance with some example embodiments described herein;

FIGS. 10A and 10B illustrate perspective full view and a perspective isolated view, respectively, of an example terminal contact housing in accordance with some example embodiments described herein; and

FIGS. 11A and 11B illustrate an isolated cross-sectional view and a cross-sectional view, respectively, of an example key switch assembly in accordance with some example embodiments described herein.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

It should be understood at the outset that although illustrative implementations of one or more aspects are illustrated below, the disclosed assemblies, systems, and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents. While values for dimensions of various elements are disclosed, the drawings may not be to scale.

The words “example,” or “exemplary,” when used herein, are intended to mean “serving as an example, instance, or illustration.” Any implementation described herein as an “example” or “exemplary embodiment” is not necessarily preferred or advantageous over other implementations.

Having described example embodiments, the design of the various devices performing various example operations is provided below. The components illustrated in the figures represent components that may or may not be present in various embodiments of the disclosure described herein such that embodiments may include fewer or more components than those shown in the figures while not departing from the scope of the disclosure.

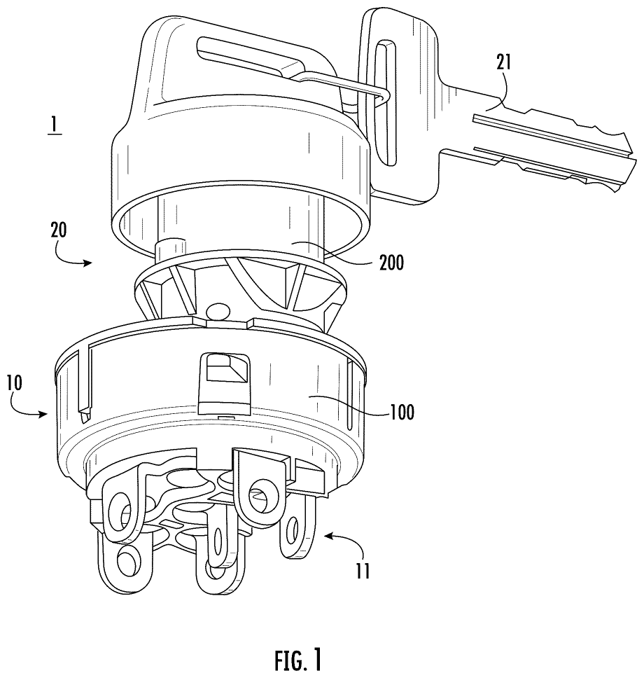

FIG. 1 illustrates a perspective view of an example key switch assembly in accordance with some example embodiments described herein. As illustrated, an exemplary key switch assembly 1 may comprise a terminal contact assembly 10 and a cylinder assembly 20. The terminal contact assembly 10 of the exemplary key switch assembly 1 may be configured to facilitate the mounting of the key switch assembly 1 to a mounting destination in an operable configuration within an operating environment. For example, in various embodiments, the terminal contact assembly 10 may be configured for physically and/or electronically coupling to an operating device (not shown), such as, for example, a vehicle. In various embodiments, the key switch assembly 1 may be installed at an operating device by physically securing at least a portion of a terminal contact housing 100 of the terminal contact assembly 10 relative to the operating device at a mounting destination defined by the operating device. Further, installing the key switch assembly 1 may include electronically connecting one or more terminal connectors 11 defined by the terminal contact assembly 10 to one or more electronic components of the operating device via the terminal contact assembly 10 such that the key switch assembly 1 may be operated to at least partially control and/or initiate one or more functions of the operating device. at the operating device.

In various embodiments, an exemplary key switch assembly 1 may further comprise a key cylinder assembly 20 that is configured for attachment to the terminal contact assembly 10 to assemble the key switch assembly 1 in an assembled configuration. In various embodiments, the key cylinder assembly 20 may be configured to receive a user engagement therewith and, based on the user engagement, one or more components of the key cylinder assembly 20 provided within an interior portion of a key cylinder housing 200 (e.g., a dynamic contact element, as described herein) may be configured to move relative to the terminal contact assembly to facilitate the selective adjustment of the key switch assembly 1 between various operational configurations thereof (e.g., ON, OFF, SETTING 1, SETTING 2, and/or the like). For example, in various embodiments, the key cylinder assembly 20 may be configured to require that a key 21 be inserted into a key slot defined by the key switch housing 200 in order to move the one or more dynamic components of the key switch assembly 20 such that the key switch assembly 1 may be adjusted between various the operational configurations thereof.

In various embodiments, the key switch assembly 1 may be configured in an assembled configuration, as shown, by causing the key cylinder assembly 20 to physically engage the terminal contact assembly 10 such that a terminal contact housing 100 of the terminal contact assembly 10 is engaged with and secured relative to the key cylinder housing 200 of the key cylinder assembly 20. In various embodiments, for example, at least a portion of the key cylinder housing 200 may be pressed into and/or against at least a corresponding portion(s) of the terminal contact housing 100 so as to establish one or more engagements of the key cylinder housing 200 with the terminal contact housing 100. As described in further detail herein, the terminal contact housing 100 and the key cylinder housing 200 may each define corresponding snap features configured to establish an at least partial physical connection between the terminal contact assembly 10 and the key switch assembly 20 as the terminal contact housing 100 and the key cylinder housing 200 are being pressed and/or otherwise moved towards and/or against one another. For example, in various embodiments, the terminal contact assembly 10 may comprise a first snap feature that is defined by the terminal contact housing 100 and configured to engage a corresponding second snap feature defined by the key cylinder housing 200 of the key cylinder assembly 20 to establish a connection between the terminal contact housing 100 and the key cylinder housing 200 at which the range of relative motion between the terminal contact housing 100 and the key cylinder housing 200 is restricted in one or more directions so as to at least partially secure the key cylinder housing 200 in an assembly position relative to the terminal contact housing 100.

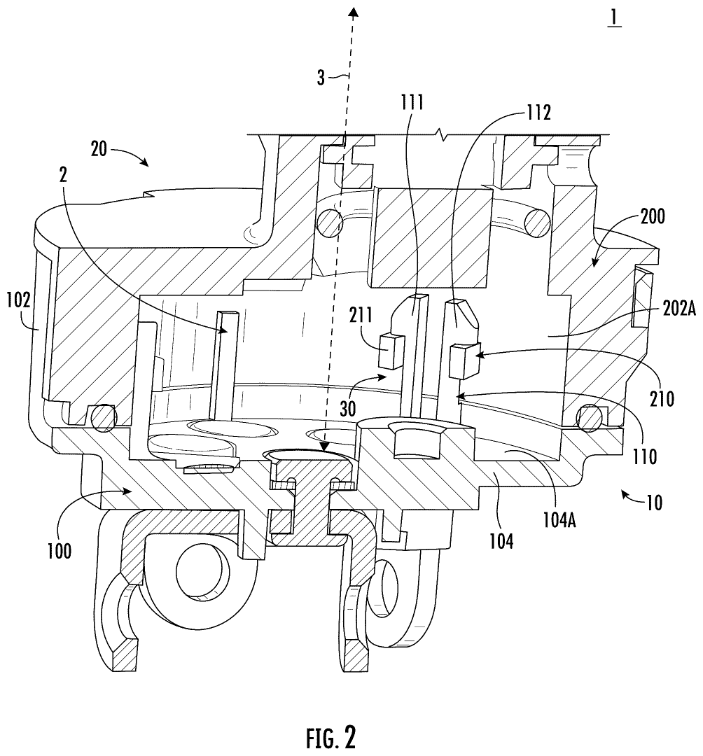

An exemplary key switch assembly 1, upon being configured in an assembled configuration, may have an internal chamber that is at least substantially isolated from an external environment of the key switch assembly 1, within which the key switch assembly 1 is configured to house various operational components thereof (e.g., various electronic components) such that the operational components remain at least substantially isolated and/or protected from various environmental conditions, forces, contaminants, and/or the like present within the external environment. In various embodiments, the internal chamber of the exemplary key switch assembly 1 may be defined by respective interior portions of the terminal contact housing 100 and the key cylinder housing 200 that, when the key switch assembly 1 is provided in an assembled configuration, collectively define an interior volume within an exterior shell that is defined collectively by the terminal contact housing 100 and the key cylinder housing 200. As a non-limiting example, FIG. 2 illustrates an isolated cutaway view of an exemplary key switch assembly in accordance with some example embodiments described herein. As illustrated, the key cylinder housing 200 of the key cylinder assembly 20 may be engaged with the terminal contact housing 100 of the terminal contact assembly 10 such that respective portions of the terminal contact housing 100 and the key cylinder housing 200 collectively define an exterior shell of the key switch assembly 1 having an internal chamber 2 defined by the interior volume within the exterior shell (e.g., between respective interior surfaces of the terminal contact housing 100 and the key cylinder housing 200).

In various embodiments, the terminal contact assembly 10 may be configured for attachment to the key cylinder assembly 20 via one or more engagement of the terminal contact housing 100 with the key cylinder housing 20. For example, as illustrated in the exemplary embodiment of FIG. 2, the one or more engagement of the terminal contact housing 100 with the key cylinder assembly 200 may be defined at least in part by a positive snap connection 30 at which a first snap feature 110 of the terminal contact housing 100 is physically engaged with a corresponding second snap feature 210 of the key cylinder housing 200 to at least partially secure the terminal contact housing 100 relative to the key cylinder housing 200. The exemplary key switch assembly 1 is configured such that as the terminal contact assembly housing 100 and the key cylinder assembly 200 are being assembled relative to one another (e.g., pushed together along an assembly axis 3 defined in an axial direction), one or more first snap features 110 defined by the terminal contact housing 100 may physically engage a corresponding second snap feature 210 defined by the key cylinder housing 200. As described in further detail herein, the first and second snap features 110, 210 may be configured to facilitate a positive snap connection, wherein as the terminal contact housing 100 and the key cylinder housing 200 continue to be moved relative to one another (e.g., pressed together) along axis 3 towards their respective assembled configurations, the first snap feature 110 is moved into a locked position relative to the second snap feature 210 with which it is engaged. For example, in various embodiments, the first snap feature 110 may be moved in a first direction relative to the second snap feature 210 with which it is engaged, such as, for example, along an axis parallel with the assembly axis 3, until the first snap feature 110 is moved beyond a threshold locking position, at which point the first snap feature 110 is disposed in a locked configuration relative to the second snap feature 210 wherein the second snap feature 210 functions as a physical barrier that restricts the range of relative motion of the first snap feature 110 relative thereto such that the first snap feature 110 is prevented from disengaging the second snap feature 210 (e.g., by being moved at least in an opposite direction parallel to the assembly axis 3 and away from the second snap feature 210). Further, in various embodiments, the positive snap connection defined by the first snap feature and second snap feature 210 may be defined by the first snap feature 110 engaged with the second snap feature 210 being rearranged into the locked position upon a pressing force that is at least substantially greater than a threshold locking force being first snap feature 110 in a direction at least substantially toward the second snap feature 210 (e.g., along the assembly axis 3). The first and second snap features 110, 210 being configured to facilitate a positive snap action during the assembly of the key switch assembly 1 allows for a simplified assembly operation that effectively locks the terminal contact housing 100 and the key cylinder housing 200 in assembled positions relative to enable operation of the key switch assembly 1 without requiring further actions or assembly steps to prevent undesirable disassembly between the terminal contact assembly 10 and the key cylinder assembly 20.

In various embodiments, key switch assembly 1 may be configured such that the one or more positive snap connection 30 defined by one or more first snap feature 110 of the terminal contact housing 100 and the corresponding second snap feature 210 defined by the key cylinder housing 200 is defined within the internal chamber 2 of the key switch assembly 1. For example, upon the key switch assembly 1 being provided in the assembled configuration, the first snap feature 110 and the second snap feature 210 engaged therewith to defined the positive snap connection 30 may each be disposed within the internal chamber 2 such that the positive snap connection 30 is physically inaccessible (e.g., to a user and/or any other external objects) from an exterior of the key switch assembly 1. As described herein, such an arrangement of the positive snap connection(s) 30 facilitates a key switch assembly 1 having a tamper-proof design, wherein the positive snap connection 30 (e.g., the first snap feature 110 secured in a locked position relative to the second snap feature 210) cannot be accidentally touched, disengaged, and/or otherwise tampered with by operators or other external forces.

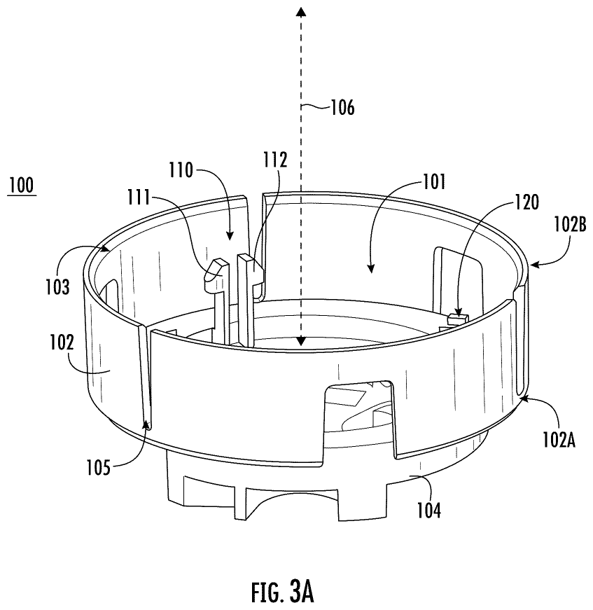

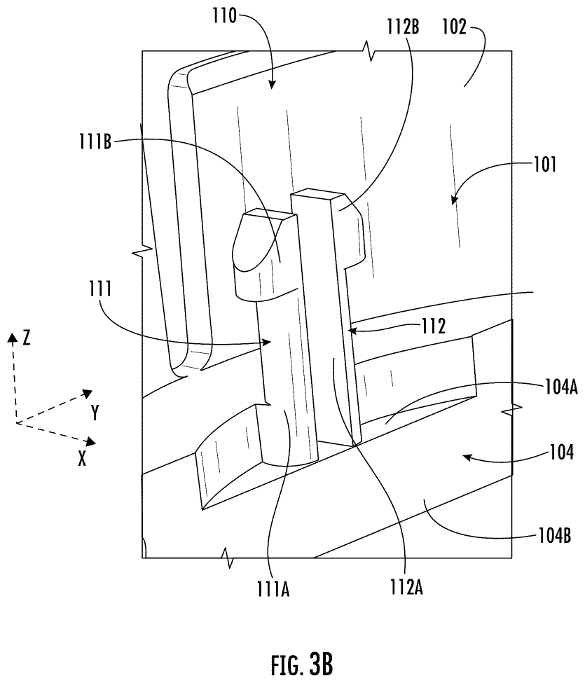

FIGS. 3A and 3B illustrate a perspective full view and a perspective isolated view, respectively, of an example terminal contact housing in accordance with some example embodiments described herein. As illustrated, in various embodiments, an exemplary terminal contact housing 100 may comprise a housing sidewall 102 having an at least substantially cylindrical configuration such that the housing sidewall 102 extends about a central axis 106 to define an outer perimeter of the terminal contact housing 100. Further, the terminal contact housing 100 may comprise a housing base 104 provided at a first end 102A of the housing sidewall 102 and a housing opening 103 provided at a second end 102B of the housing sidewall 102, within which the terminal contact housing 100 may be configured to receive at least a portion of the key cylinder assembly during the assembly of an exemplary key switch assembly, as described herein. In various embodiments, the housing base 104 may define one or more interior base surface(s) 104A oriented in a direction at least substantially towards the housing opening 103 that collectively with an interior sidewall surface 102C of the housing sidewall 102 provide an outer boundary for the interior portion 101 of the terminal contact housing 100. In various embodiments, an exemplary terminal contact assembly may comprise one or more electrical contacts (not shown) arranged about the interior base surface 104A of the housing base 104 that are configured to interface with corresponding electrical contacts of the key cylinder assembly (e.g., upon the key switch assembly being arranged in an assembled configuration) in order to facilitate operation of the key switch assembly. As described herein, an assembly operation for coupling the key cylinder assembly with the terminal contact assembly may comprise providing at least a portion of the key cylinder housing within the interior portion of the terminal contact housing 100 (e.g., through the housing opening 103) in a direction at least substantially along the central axis 106 and towards the interior base surface 104A of the housing base 104 until the one or more first snap feature 110 of the terminal contact housing 100 engages a corresponding one or more second snap feature of the key cylinder housing to establishes a positive snap connection. In various embodiments, the housing sidewall 102 may comprise one or more alignment slots 105 provided along the length of the sidewall (e.g., in a direction at least substantially parallel to the axis 106) that extend from the housing opening 103 at the second sidewall end 102B towards the first sidewall end 102A and are configured to receive corresponding alignment protrusions defined by the key cylinder housing to facilitate proper alignment of the respective components and function as physical guides to ensure that the first snap features 110 and second snap features defined by the terminal contact housing and the key cylinder housing, respectively, remain in an aligned configuration sufficient to establish a positive snap connection, as described herein.

In various embodiments, the terminal contact housing 100 may comprise one or more first snap features 110 extending from an interior surface of the terminal contact housing 100 in a direction at least substantially towards the opening 103. For example, in various embodiments, the one or more first snap feature 110 may be configured to protrude (e.g., at least substantially perpendicularly) away from an interior surface defined by the housing base 104 in a direction that is at least substantially parallel to a central axis 106 defined by the hosing sidewall 102. As illustrated, each first snap feature 110 defined by the terminal contact housing 100 may be disposed within an interior portion of the terminal contact housing such that, during assembly of the terminal contact housing 100 relative to the key cylinder housing of the key switch assembly, each first snap feature 110 may engage a corresponding second snap feature provided within the interior portion of the key cylinder housing to enable a positive snap connection that is arranged within the internal chamber of the key switch assembly. As a non-limiting example, the terminal contact housing 100 may comprise a plurality of first snap features 110, 120 distributed about the interior portion 101 of the terminal contact housing 100 that each define a male snap feature configured for snap engagement with a corresponding female snap feature provided within an interior portion of the key cylinder housing to at least partially secure the terminal contact housing 100 relative to the key cylinder housing (e.g., via respective positive snap connections).

In various embodiments, as illustrated in FIG. 3B, an exemplary first snap feature 110 of the terminal contact housing 100 may comprise a male snap feature that protrudes from an interior surface of the terminal contact housing 100, such as, for example, the interior base surface 104A, and extends in a direction at least substantially towards the housing opening defined by the terminal contact housing 100. For example, as illustrated, an exemplary first snap feature 110 may comprise a male snap feature that extends from the interior base surface 104A in a direction at least substantially perpendicular thereto (e.g., in the positive z-direction, as illustrated in the exemplary orientation of the embodiment shown in FIG. 3B) and/or parallel with the central axis of the housing sidewall 102. In various embodiments, an exemplary first snap feature 110 defined by the terminal contact housing 100 may comprise at least one protrusion arm having a snap head provided at a distal end of each protrusion arm that is configured to facilitate a positive snap action upon engagement with a corresponding second snap feature of the key cylinder housing. As illustrated, the first snap feature 110 comprises a pair of protrusion arms 111, 112, each having a shaft 111A, 112A that extends outwardly from the interior base surface 104A to a respective snap head 111B, 112B provided at the distal end of each shaft 111A, 112A. In various embodiments, the respective shafts 111A, 112A of the pair of protrusion arms are laterally spaced from one another so as to define a lateral gap therebetween. In various embodiments, the snap head 111B, 112B of each protrusion arm 111, 112 defining the first snap feature 110 may be is defined at least in part by an angled surface oriented in a respective outward direction facing at least partially away from the corresponding shaft 111A, 112A. As a non-limiting example, in various embodiments, the angled surface of a snap head 111B, 112B of an exemplary first snap feature 110 may define a pitch angle of at least approximately between 20 degrees and 70 degrees (e.g., between 35 degrees and 55 degrees).

The first snap feature 110 may be configured to engage the second snap feature of the key cylinder housing by via the angled surfaces of each snap head 111B, 112B physically abutting respective surfaces of the second snap feature. Each first snap feature 110 of the terminal contact housing 100 may be configured to engage a corresponding second snap feature via a physical engagement at the snap head 111B, 112B (e.g., the respective angled surface thereof) and enable a movement of the first snap feature 110 relative to the corresponding second snap feature in a connecting direction towards a locked position. Further, the protrusion arms 111, 112 may be configured such that at least a portion of the snap head 111B, 112B defines a flange that extends from the distal end of the shaft 111A, 112A at an at least substantially right angle to define an engagement surface oriented in a direction at least partially towards the interior base surface 104A at which the snap head 111B, 112B is configured to physically engage a corresponding surface of the second snap feature to secure the first snap feature 110 in a locked position by preventing the first snap feature 110 from moving back in the opposite disengagement direction relative to the second snap feature (e.g., in the negative z-direction, as illustrated in the exemplary orientation of the embodiment shown in FIG. 3B). For example, in various embodiments, the flange of the snap head 11B, 112B may extend from the distal end of the shaft 111A, 112A at an angle of at least approximately between 85 degrees and 95 degrees (e.g., at least approximately 90 degrees) relative to the central axis of the shaft 111A, 112A.

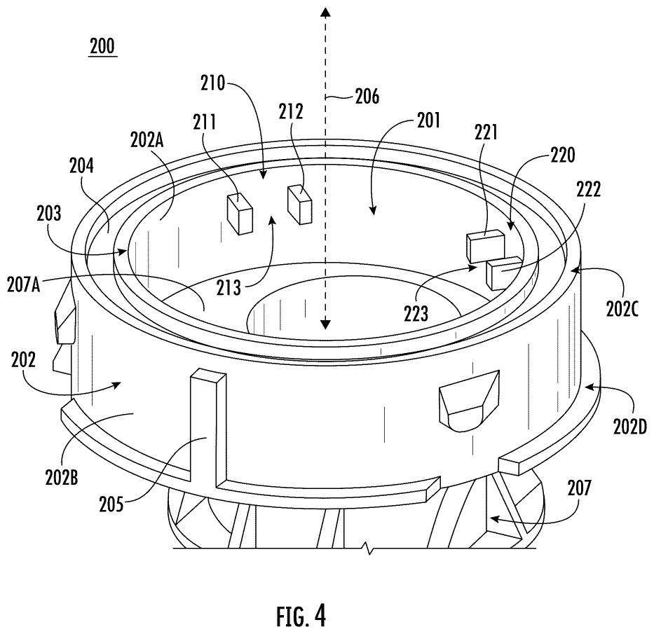

FIG. 4 illustrates a perspective full view and a perspective isolated view of an example key cylinder assembly in accordance with some example embodiments described herein. As illustrated, in various embodiments, an exemplary key cylinder housing 200 may comprise a housing sidewall 202 having an at least substantially cylindrical configuration such that the housing sidewall 202 extends about a central axis 206 and has a sidewall thickness that is defined in a radial direction relative to the central axis 206 between an outer sidewall surface 202B and an interior sidewall surface 202A. Further, the key cylinder housing 200 may comprise a housing body 207 disposed relative to a first end 202C of the housing sidewall 202, and a housing opening 203 provided at a second end 202B of the housing sidewall 202. In various embodiments, the housing body 207 may define one or more interior body surface(s) 207A oriented in a direction at least substantially towards the housing opening 203 that collectively with an interior sidewall surface 202A of the housing sidewall 202 provide an outer boundary for the interior portion 201 of the key cylinder housing 200.

In various embodiments, the first end 202C of the housing sidewall 202 of the key cylinder housing 200 may define one or more engagement surfaces at which the key cylinder housing 200 is configured to physically engage one or more surfaces of the terminal contact housing when the key switch assembly is in an assembled configuration. As illustrated, in various embodiments, the housing sidewall 202 may comprise an O-ring channel 204 that is defined by a continuous material recess that spans the circumference of the first end 202C of the housing sidewall 202 and recesses into the housing sidewall 202 (e.g., in a direction at least substantially toward the second end 202B of the housing sidewall 202) so as to define a circumferential channel within which an O-ring may be disposed to facilitate an at least substantially sealed (e.g., air-tight) interface between the key cylinder housing 200 and the terminal contact housing when the key switch assembly is in an assembled configuration.

In various embodiments, the housing sidewall 202 may comprise one or more alignment ridges 205 provided along the outer sidewall surface 202B of the housing sidewall 202 that is configured to protrude an outward radial direction away from the outer sidewall surface 202B such that the alignment ridges 205 may be received with a corresponding one or more alignment slots defined by the housing sidewall of the terminal contact housing during assembly of the key cylinder and terminal contact assemblies.

In various embodiments, the key cylinder housing 200 may comprise one or more second snap features 210 provided along an interior sidewall surface 202A of the key cylinder housing 200 and configured to receive and/or otherwise engage the one or more first snap features defined by the terminal contact housing to establish the one or more positive snap connections within the internal chamber of the key switch assembly. In various embodiments, for example, as illustrated in FIG. 4, each second snap feature 210 defined by the key cylinder housing 200 may comprise one or more retention arms protruding at least substantially perpendicularly from the interior sidewall surface 202A in an at least partially inward radial direction (e.g., at least partially towards the central axis 206). As illustrated, each second snap feature 210 defined by the key cylinder housing 200 may be disposed within an interior portion 201 of the key cylinder housing 200 such that, during assembly of the key cylinder housing 200 relative to the terminal contact housing as described herein, each second snap feature 210 may engage a corresponding first snap feature provided within the interior portion of the terminal contact housing to enable a positive snap connection that is arranged within the internal chamber of the key switch assembly. As a non-limiting example, the key cylinder housing 200 may comprise a plurality of second snap features 210, 220 distributed about the interior portion 201 of the key cylinder housing 200 that each define a female snap feature configured to receive a corresponding male snap feature provided within the interior portion of the terminal contact housing to at least partially secure the key cylinder housing 200 relative to the terminal contact housing (e.g., via respective positive snap connections).

In various embodiments, as illustrated, an exemplary second snap feature 210 of the key cylinder housing 200 may comprise a female snap feature comprising at least one retention arm configured to extend away from the interior sidewall surface 202A of the housing sidewall 202 so as to define a gap, an aperture, a channel, a slot, an opening, and/or any other space adjacent at least one retention arm at and/or within which a first snap feature of the terminal contact housing (e.g., one or more snap heads) may be received to facilitate an engagement with the second snap feature 210 that establishes a positive snap connection therebetween. As illustrated, the second snap feature 210 may comprise a pair of retention arms 211, 212 that each extend away from the interior sidewall surface 202A in respective inward directions into the interior portion 201 of key cylinder housing 200. In various embodiments, the retention arms 211, 212 are laterally spaced apart from one another so as to define a lateral gap therebetween within which the second snap feature 211 may be configured to receive a corresponding first snap feature (e.g., a pair of protrusion arms) to initiate the positive snap action that establishes the positive snap connection therebetween. In various embodiments, the snap head 111B, 112B of each protrusion arm 111, 112 defining the first snap feature 110 may be is defined at least in part by an angled surface oriented in a respective outward direction facing at least partially away from the corresponding shaft 111A, 112A.

As a non-limiting example, the key cylinder housing 200 may comprise a plurality of second snap features 210, 220 distributed about the interior portion 201 of the key cylinder housing 200 that each define a female snap feature configured for snap engagement with a corresponding male snap feature provided within an interior portion of the terminal contact housing, as described herein, to at least partially secure the key cylinder housing 200 relative to the terminal contact housing.

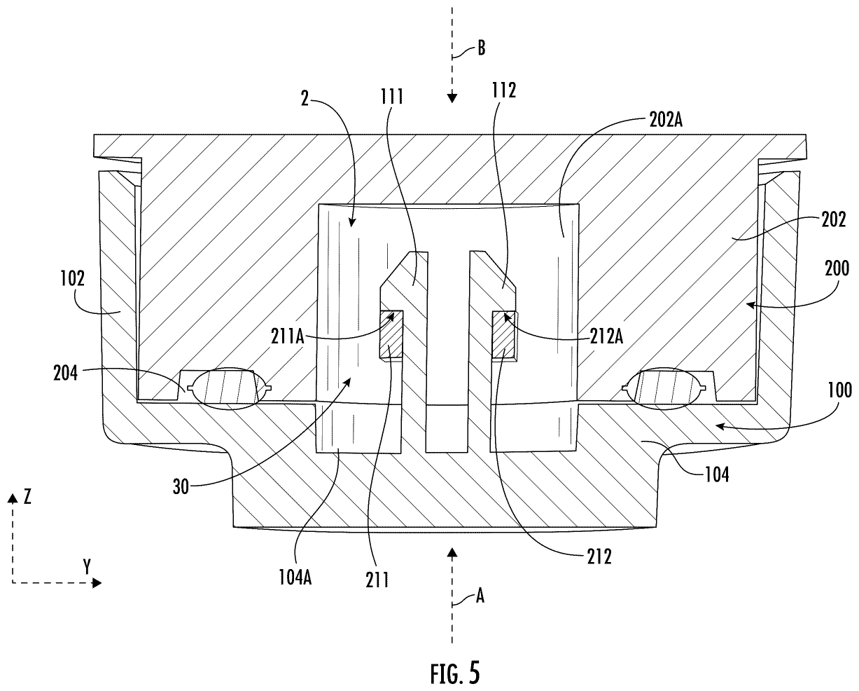

FIG. 5 illustrates an isolated cross-sectional view of an example key switch assembly in accordance with some example embodiments described herein. In particular, FIG. 5 illustrates various components of an exemplary key switch assembly in an assembled configuration, wherein the terminal contact housing 100 and the key cylinder housing 200 are secured relative to one another via a positive snap connection 30 defined within an internal chamber 2. As illustrated, the terminal contact assembly is attached to the key cylinder assembly via the engagement of the first snap feature 110 defined by the terminal contact housing 100 with the corresponding second snap feature 210 defined by the key cylinder housing 200. The positive snap connection 30 is defined by the arrangement of the first snap feature 110 in the locked position relative to the second snap feature 210. For example, the positive snap connection 30 may be established by moving the key cylinder housing 200 relative to the terminal contact housing 100 (e.g., causing the key cylinder housing 200 to move in the illustrated B direction and/or causing the terminal contact housing 100 to move in the illustrated A direction toward the key cylinder housing 200) relative to the terminal contact housing 100 such that at least a portion of the housing sidewall 202 of the key cylinder housing 200 is received within the interior portion of the terminal contact housing 100. In various embodiments, as the terminal contact housing 100 and the key cylinder housing 200 are moved in directions A and B relative to one another, respectively, the first snap feature 110 is configured to engage each of the pair of retention arms 211, 212 via a respective angled surface defined by the snap head of one of the pair of protrusion arms 111, 112. The physical engagement of the first and second snap features and the angled configuration of the protrusion arm 111, 112 angled surfaces cause the respective protrusion arms to be laterally compressed towards each other such that the lateral gap there between is reduced and the respective snap heads of the protrusion arms 111, 112 are each channeled through lateral gap defined between the retention arms 211, 212. The terminal contact housing 100 and the key cylinder housing 200 being further pressed against each other may cause the first snap feature 110 to be moved (e.g., in the A direction) beyond a threshold locking position such that the angled surface of the protrusion arms 111, 112 disengage the respective retention arms 211, 212. In various embodiments, the positive snap connection 30 may be defined by the first snap feature 110 being secured in a locked position wherein the respective flange that extends at substantially a 90-degree angle from the protrusion arm shaft of the respective protrusion arm 111, 112 is engaged with a respective engagement surface 211A, 212A of each retention arm 211, 212 of the second snap fastener 210. In the locked position, the flange surface of each protrusion arm 111, 112 may be oriented to face in an at least substantially opposite direction as the engagement surface 211A, 212A engaged therewith such that the retention arms 211, 212 of the second snap fastener 210 function as physical barriers that prevent the first snap feature 110 and thus, the terminal contact housing 100 as a whole from moving in the illustrated B-direction relative to the key cylinder housing 200. The exemplary key switch assembly described herein is configured such that the positive snap connection 30 defined in an internal chamber 2 of the key switch assembly may be established by applying a pressing force to one or both of the key cylinder assembly and the terminal contact assembly that causes the key cylinder housing 200 and the terminal contact housing 100 to be pressed against one another as described herein, without any further assembly operations and/or user interactions being required to secure the first snap feature 110 in a locked position relative to the corresponding second snap feature within the internal chamber 2. As described in further detail herein, the first snap features 110 of the terminal contact housing and the corresponding second snap features 210 of the key cylinder housing 200 may be configured to engage one another such that, in the locked position, as illustrated, a clamping force is generated by the positive snap connection that acts to secure the terminal contact assembly 10 in a particular position relative to the key cylinder assembly 20. For example, the first and second snap features 110, 210 may be configured to establish a position snap connection that causes a clamping force to be applied to one or more of the terminal contact housing 100 and the key cylinder housing 200 to maintain the relative positioning of respective terminal contacts housed therein throughout operation of the key switch assembly 1.

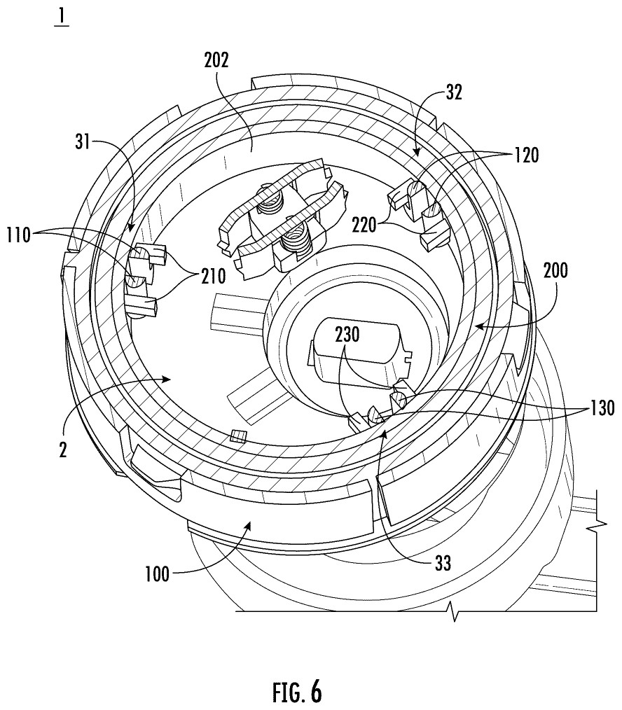

FIG. 6 illustrates a cross-sectional view of various components of an example key switch assembly in accordance with some example embodiments described herein. In particular, FIG. 6 illustrates an exemplary embodiment wherein a terminal contact assembly of the key switch assembly 1 is secured relative to the key cylinder assembly by a plurality of positive snap connections defined within the internal chamber 2 of the key switch assembly 1. As illustrated, in various embodiments, an exemplary key switch assembly 1 may comprise a terminal contact housing 100 having a plurality of first snap elements disposed within an interior portion of the terminal contact housing 100 and a key cylinder housing 200 having a corresponding plurality of second snap elements disposed within an interior portion of the key cylinder housing 200. In various embodiments, each of the plurality of first snap features defined by the terminal contact housing 100 may correspond to a respective second snap feature of the plurality of second snap features defined by the key cylinder housing 200, such that the attachment of the terminal contact assembly to the key cylinder assembly may be defined by a plurality of engagements between the terminal contact housing 100 and the key cylinder housing 200 at each of the plurality of corresponding pairs of first and second snap features. For example, as illustrated in the exemplary embodiment of FIG. 6, the terminal contact housing 100 defines three first snap features 110, 120, 130, each of which is secured in a respective locked position relative to a corresponding one of the three second snap features 210, 220, 230 defined by the key cylinder housing 200 such that the terminal contact assembly and the key cylinder assembly are attached via a plurality of three positive snap connections 31, 32, 33. As a non-limiting example, an exemplary key switch assembly may be configured to include at least approximately between one positive snap connection and ten positive snap connections (e.g., between three positive snap connections and five positive snap connections) defined within the internal chamber of the key switch assembly.

In various embodiments, the terminal contact housing 100 and the key cylinder housing 200 may be configured such that the plurality of positive snap connections 31, 32, 33 defined within the internal chamber 2 are evenly distributed about a central axis of the cylindrical sidewall 202 of the key cylinder housing 200. For example, the angular distance between each adjacent positive snap connection of the plurality of positive snap connections (e.g., as defined relative to the central axis of the key cylinder housing 200) is at least substantially the same. For example, each of the evenly distributed positive snap connections may be at least substantially equidistant from at least two of the other positive snap connections of the plurality of positive snap connections. The plurality of positive snap connections may be provided within an internal chamber 2 such that the positive snap connections are evenly distributed about an internal perimeter of the internal chamber 2. For example, in an embodiment wherein the plurality of positive snap connections includes three positive snap connections, as shown, the angular distance between adjacent positive snap connections may be at least approximately 120 degrees. Alternatively, as a non-limiting example, in an embodiment wherein the plurality of positive snap connections includes four positive snap connections, the angular distance between each of the adjacent positive snap connections may be at least approximately 120 degrees.

As described herein, the plurality of positive snap connections 31, 32, 33 defined by an exemplary key switch assembly 1 may be arranged along an interior sidewall surface of the sidewall 202 defined by the key cylinder housing 200 and evenly distributed about the central axis of the sidewall 202 such that various forces generated within the key switch assembly 1 as a result of the key cylinder assembly 20 being secured to the terminal contact assembly 10 via the plurality of positive snap connections (e.g., one or more squeezing forces acting on an O-ring disposed between adjacent surfaces of the key cylinder housing 200 and the terminal contact housing 100, one or more clamping forces defined between the key cylinder housing 200 and the terminal contact housing 100, and/or the like) are at least substantially evenly distributed about the central axis defined by the cylindrical sidewall 202.

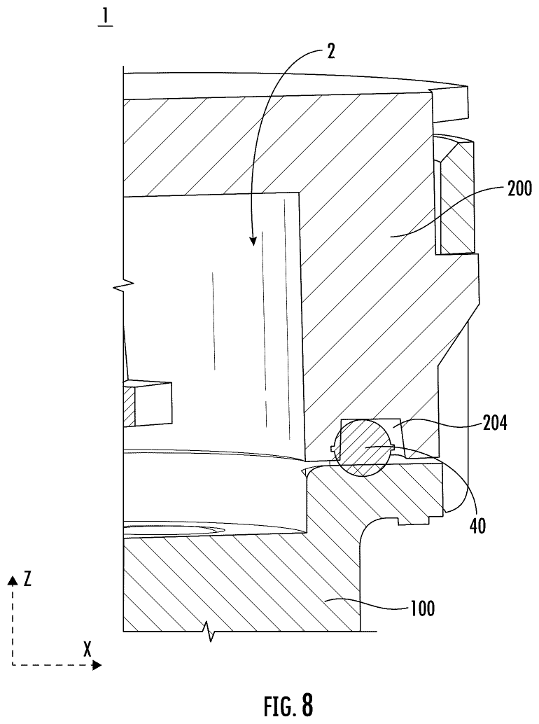

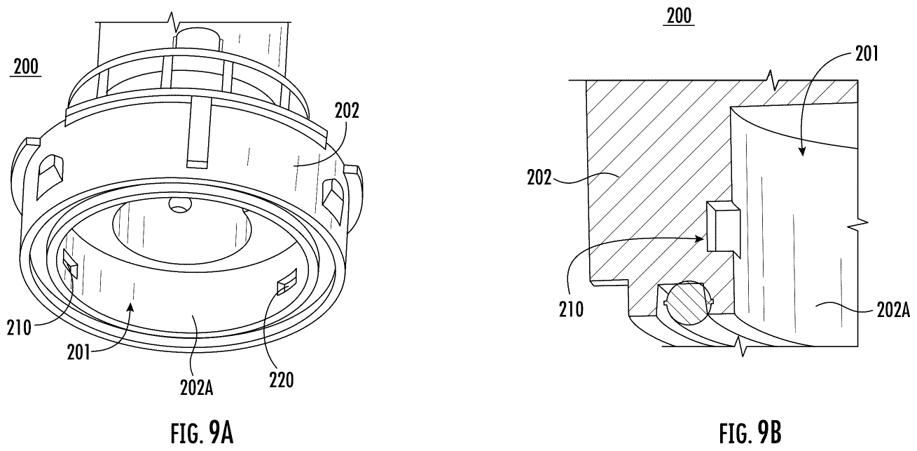

FIGS. 9A-11B illustrate various views of an exemplary key switch assembly having one or more positive snap connections defined by respective snap features of the terminal contact housing and key cylinder housing thereof. In particular, FIGS. 9A-11B illustrate various components of an exemplary key switch assembly wherein each of the one or more positive snap features is defined by an engagement between a second snap feature embodying a material recess provided at an interior surface of the housing sidewall and a correspondingly configurated first snap feature having a single protrusion arm. For example, FIGS. 9A and 9B illustrate a perspective full view and a perspective isolated view, respectively, of an example key cylinder housing 200 wherein the one or more second snap features 210 are each defined by a material recess that is provided at the interior surface 202A of the housing sidewall 202 of the key cylinder housing 200 and recesses into the housing sidewall 202. In various embodiments, each of the second snap features 210 illustrated in the exemplary key cylinder housing 200 shown in FIGS. 9A and 9B are configured for engaging a respective first snap feature of the terminal contact housing to define a respective positive snap connection by receiving at least a portion of the snap head (e.g., a flange portion) of a corresponding first snap feature within the material recess defining the second snap feature 210. As a non-limiting example, the key cylinder housing 200 may comprise a plurality of second snap features 210, 220 distributed about the interior portion 201 of the key cylinder housing 200 that each define a female snap feature configured to receive a corresponding male snap feature provided within the interior portion of the terminal contact housing to at least partially secure the key cylinder housing 200 relative to the terminal contact housing (e.g., via respective positive snap connections).

In various embodiments wherein the exemplary key switch assembly comprises a key cylinder housing 200 having second snap features 210, 220 that are defined by respective material recesses arranged about the interior surface 202A of the housing sidewall 202 of the key cylinder housing 200, the exemplary key switch assembly may further comprise a terminal contact housing that defines corresponding first snap features configured for engagement with the material recesses provided along the interior sidewall surface 202A.

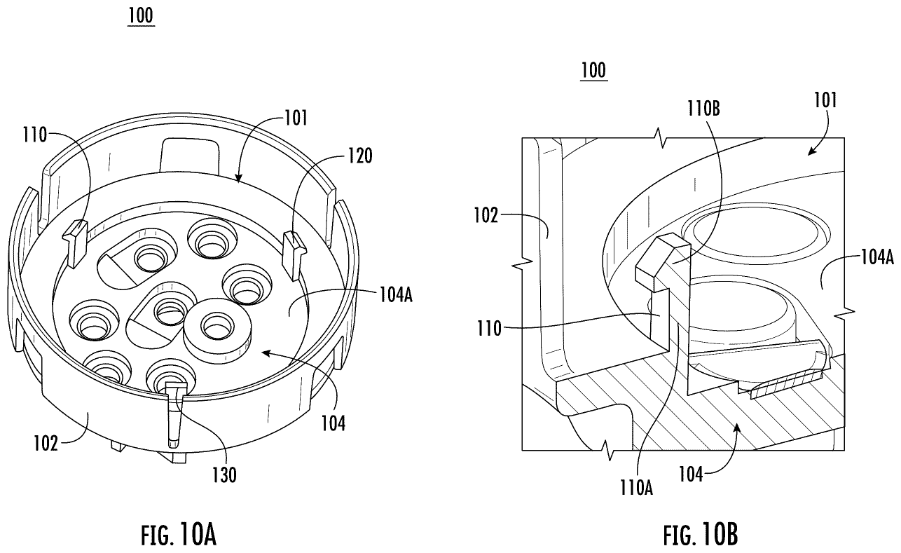

For example, FIGS. 10A and 10B illustrate a perspective full view and a perspective isolated view, respectively, of an example terminal contact housing in accordance with some example embodiments described herein. As illustrated, the exemplary terminal contact housing 100 may comprise first snap features 110, 120 that are configured for engagement with the material recesses defining the second snap features 210, 220 of the exemplary key cylinder housing 200 shown in FIGS. 9A and 9B. In various embodiments, as illustrated in FIG. 10B, each of the plurality of first snap features 110, 120, 130 may comprise a singular protrusion arm. For example, a first snap feature 110 may comprise a singular protrusion arm having a shaft 110A that extends outwardly from the interior base surface 104A to a snap head 110B provided at the distal end of the shaft 110A. In such an exemplary configuration, the protrusion arms of each first snap feature 110 may be configured such that at least a portion of the snap head 110B defines a flange that extends from the distal end of the shaft 110A at an at least substantially right angle (e.g., at an angle of at least approximately between 85 degrees and 90 degrees) to define an engagement surface oriented in a direction at least partially towards the interior base surface 104A. As illustrated, a first snap feature 110 configured for engagement with a second snap feature that embodied by a material recess in the sidewall of the key cylinder housing may be configured such that the flange defined by the snap head 110B of the first snap feature 100 is oriented to extend from the distal end of the shaft 110A in a direction at least substantially toward an interior sidewall surface of the housing sidewall 102 defined by the terminal contact housing 100 (e.g., in an at least substantially radially outward direction, as defined relative to a central axis of the cylindrical sidewall 102 of the terminal contact housing 100).

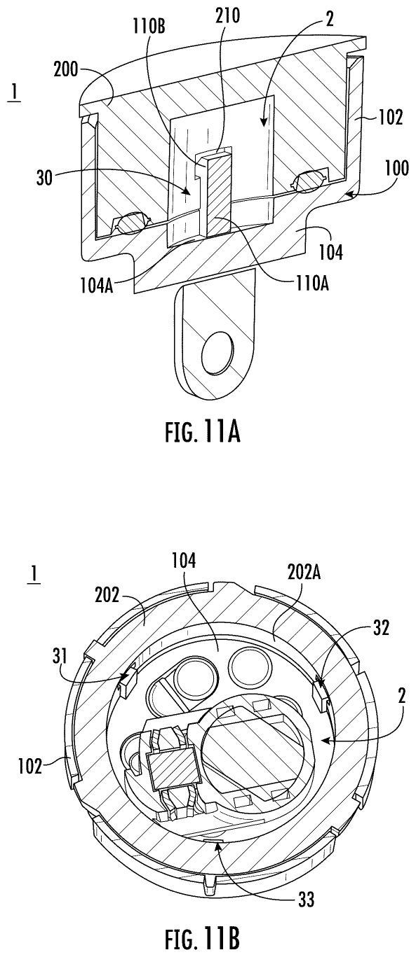

As illustrated in FIGS. 11A and 11B, each first snap feature 110 may be oriented such that the flange of the snap head 110B is oriented in a direction at least substantially towards an adjacent portion of the housing sidewall 102, such that as the key cylinder housing 200 is being assembled, the housing sidewall 202 of the key cylinder housing 200 towards is moved into a position in between the first snap feature 110 and the housing sidewall 102. In such an exemplary configuration, upon the key cylinder housing 200 being arranged such that a corresponding one of the material recesses defining a second snap feature 210 is at least substantially aligned with the snap head 110B of a corresponding first snap feature 110, the flange defined by the snap head 110B of the first snap feature 110 may be inserted at least partially into a corresponding material recess defined at the interior sidewall surface 202A of the key cylinder housing 200 such that the engagement surface defined by the flange of the snap head 110B may physically engage a corresponding surface within the material recess of the second snap feature 210 to secure the first snap feature 110 (e.g., the snap head 110B) in a locked position by preventing the first snap feature 110 from moving back in the opposite disengagement direction relative to the second snap feature 210, as described herein. As described herein, the more engagement of the terminal contact housing 100 with the key cylinder assembly 200 may be defined at least in part by a positive snap connection 30 at which a first snap feature 110 of the terminal contact housing 100 is physically engaged with a corresponding second snap feature 210 of the key cylinder housing 200 via the snap head 110B of the first snap feature 110 being at least partially disposed within the second snap feature 210 embodied as a material recess within the housing sidewall 202 of the key cylinder housing 200 to at least partially secure the terminal contact housing 100 relative to the key cylinder housing 200. As illustrated in the exemplary embodiment of FIG. 11B, in an exemplary configuration wherein the terminal contact housing 100 defines three first snap features 110, 120, 130, each of which is secured in a respective locked position relative to a corresponding one of three second snap features 210, 220, 230 defined by the three material recesses distributed along the interior sidewall surface 202A such that the terminal contact assembly and the key cylinder assembly are attached via a plurality of three positive snap connections 31, 32, 33.

In various embodiments, an exemplary key switch assembly 1 may be configured such that a positive snap connection defined by a first snap feature of the terminal contact assembly being secured in a locked position relative to a corresponding second snap feature of the key cylinder assembly may result in a clamping force that acts on one or both of the terminal contact housing 100 and the key cylinder housing 200. In various embodiments, the one or more positive snap connections may be configured such that the clamping force generated between the terminal contact housing 100 and the key cylinder housing 200 may function to at least partially secure an arrangement of the terminal contact assembly relative to the key cylinder assembly wherein a predetermined interference is maintained between a dynamic electronic contact of the key cylinder assembly and a static electronic contact of the terminal contact assembly throughout operation of the key switch assembly.

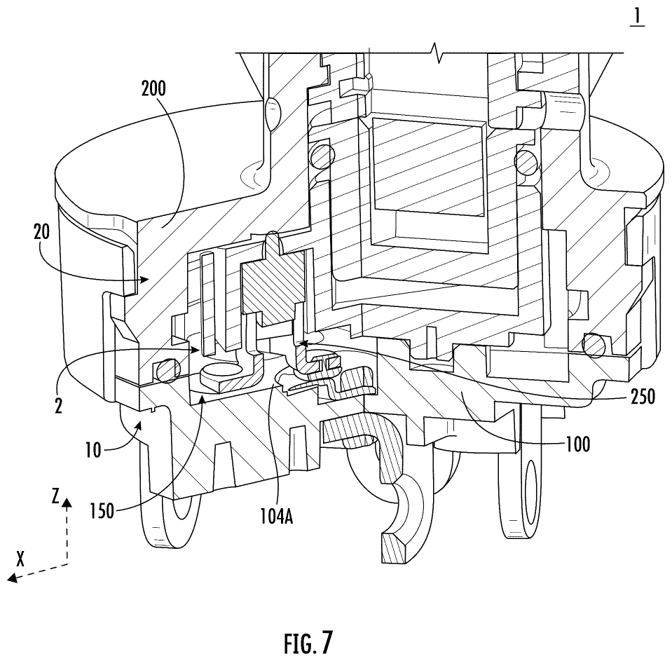

For example, FIG. 7 illustrates an isolated cutaway view of an exemplary key switch assembly in accordance with some example embodiments described herein. As illustrated, an exemplary key switch assembly 1 may comprise a terminal contact assembly 10 having a first set of contact elements 150 positioned at the interior base surface 104A of the terminal contact housing 100 and a terminal contact assembly 10 having a first set of contact elements 150 positioned at the interior base surface 104A of the terminal contact housing 100, and a key cylinder assembly 20 having a second set of contact elements 250 secured relative to one or more dynamic components of the key cylinder assembly 20 that are positioned within an interior portion of the key cylinder housing 200 such that, upon the key switch assembly 1 being provided in an assembled configuration, the second set of contact elements 250 are disposed within the internal chamber 2. For example, in various embodiments, the first set of contact elements 150 defined by the terminal contact assembly 10 may be stationary contacts that remain secured to the interior base surface 104A of the terminal contact housing 100. Further, the second set of contact elements 250 defined by the key cylinder assembly 20 may be dynamic contacts that are configured to move with the one or more dynamic components to which they are fastened during operation of the key switch assembly 1. In various embodiments, the second set of contacts 250 may define a range of motion within the internal chamber 2 that at least partially overlaps and/or moves relative to the position(s) of the first set of contact elements 150 such that, during an operation of the key switch assembly 1, a contact interface may be defined within the internal chamber 2 where at least a portion of the second set of contact elements 250 is positioned relative to (e.g., at least substantially adjacent to) one or more of the first set of contact elements 150. As a portion of the dynamic components of the key cylinder assembly 20 to which the second set of contact elements 250 are secured is rotated during operation of the key switch assembly 1, the second set of contact elements 250 (e.g., dynamic contact element(s)) is moved relative to a least a portion of the first set of contact elements 150 defined by the terminal contact assembly 100 (e.g., the stationary contacts). In various embodiments, one or more of the first set of contact elements 150 and the second set of contact elements 250 may comprise electric contacts. In such an exemplary configuration, a resistance may be defined at the contact interface between the first set of contact elements 150 and the second set of contact elements 250 that may be measured to determine the position of the second set of contact elements 250 relative to the first set of contact elements 150, which may be utilized to determine one or more operating condition of the key switch assembly 1.

In various embodiments, as key switch assembly 1 is operated and the various dynamic components of the key cylinder assembly 20 are moved between various configurations such that the second set of contact elements 250 is repeatedly moved throughout its range of motion relative to the first set of contact elements 150, a temperature increase may be realized within the internal chamber 2 (e.g., at the contact interface defined between the first and second sets of contact elements 150, 250). In various embodiments, the exemplary key switch assembly 1 may be configured to mitigate the undesirable temperature increase at the contact interface within the internal chamber 2 during operation of the key switch assembly 1 by utilizing the one or more positive snap connections to secure the key cylinder housing 200 relative to the terminal contact housing 100 in an at least substantially consistent arrangement wherein a known interference is maintained between the first set of stationary contact elements 150 of the terminal contact assembly 10 and the second set of dynamic contact elements 250 of the key cylinder assembly 20 as the dynamic contact elements within the key cylinder housing 200 are moved throughout their range of motion. For example, the interference between the first set of contact elements 150 and the second set of contact elements 250 may be defined in a linear distance by which adjacent surfaces of the respective sets of contact elements are configured to overlap to facilitate engagement therebetween at a contact interface, as defined in a direction at least substantially parallel to the central axis of the cylindrical sidewall 202 of the key cylinder housing 200 (e.g., measured in the z-direction, as illustrated in the exemplary orientation of the embodiment shown in FIG. 7), so as to maintain an operable and/or consistent electrical conductivity therethrough. For example, in various embodiments, the interference between the first set of contact elements 150 and the second set of contact elements 250 may be at least approximately between 0.005 inches and 0.030 inches (e.g., between about 0.010 inches and about 0.0175 inches).

In various embodiments, the interference may be defined based at least on one or more characteristics of the positive snap connections defined by the exemplary key switch assembly 1, such as, for example, the height of the first snap features defined by the terminal contact housing 100 and/or the position of the second snap features defined by the key cylinder housing 200 relative to the engagement surface defined at a lower edge of the key cylinder housing.

As described herein, the one or more positive snap connections defined by the exemplary key switch assembly may generate a clamping force between the terminal contact housing 100 and the key cylinder housing 200 that enables the interference between the first and second sets of contact elements 150, 250 to be maintained at an at least substantially consistent distance throughout operation of the key switch assembly 1. For example, the key switch assembly 1 being configured to maintain such an interference may facilitate increased operational efficiency and lifespan, as an at least substantially consistent interference between the static and dynamic contact elements may correspond to an at least substantially consistent and/or predictable resistance being defined at the contact interface therebetween. Further, the arrangement of the terminal contact housing 100 relative to the key cylinder housing 200 (e.g., via the positive snap connections) wherein the interference is maintained at least in part by the clamping force acting between the terminal contact housing 100 and the key cylinder housing 200 may prevent undesirable temperature rises within the internal chamber 2 of the key switch assembly 1 that can result from the operation of various dynamic components within the closed environment of the isolated internal chamber 2.

Further, in various embodiments, the first snap features and the second snap features of the terminal contact housing and the key cylinder housing, respectively may be configured such that a positive snap connect defined by an exemplary key switch assembly secures the key cylinder assembly relative to the terminal contact assembly in an arrangement wherein the terminal contact housing and the key cylinder housing apply a squeezing (e.g., compression) force to an O-ring disposed therebetween. As a non-limiting example, FIG. 8 illustrates an isolated cross-sectional view of an exemplary key switch assembly in accordance with some example embodiments described herein. As illustrated, the sidewall 102 of the terminal contact housing 100 may at least substantially surround the housing sidewall of the key cylinder housing 200 such that the interior sidewall surface of the sidewall 102 is disposed at least substantially adjacent the outer sidewall surface of the key cylinder housing 200 sidewall 202 around the entirety of the sidewall 202 outer surface perimeter. In various embodiments, the engagement surface defined at a distal end (e.g., a first end 202A, as described with respect to the exemplary embodiment of FIG. 4) may be physically engaged with at least a portion of the interior base surface of the housing base 104 such that the O-ring channel 204 is becomes enclosed by the portions of the interior base surface adjacent the O-ring channel 204.

In various embodiments, the plurality of positive snap connections (not shown) of the exemplary key switch assembly 1 may be configured to arrange the key cylinder housing 200 relative to the terminal contact housing 100 such that a compression force is applied to an O-ring 40 disposed within the O-ring channel 204 defined by the key cylinder housing 200, the compression force being sufficient to cause the O-ring 40 to provide an at least substantially air-tight seal between the terminal contact housing 100 and the key cylinder housing 200. For example, upon the plurality of positive snap connections being established to provide the key switch assembly in the assembled configuration, the compression force acting on the O-ring 40 as it is squeezed between respective portions of the terminal contact housing 100 and the key cylinder housing 200 may be sufficient to maintain an at least substantially air-tight seal around the perimeter of the internal chamber 2 throughout operation of the key switch assembly 1, so as to isolate various operational components of the key switch assembly 1 housed within the internal chamber 2 from external environmental conditions and/or contaminants (e.g., chemical splashes, pressure wash, vibration, dust, humidity, and salt, and/or the like). As described in further detail herein, the respective first and second snap features that define each of the plurality of positive snap connections of an exemplary key switch assembly 1 may be configured such that securing the terminal contact housing 100 to the key cylinder housing 200 via the plurality of positive snap connections may cause an at least substantially constant compression force to be applied to the O-ring 40 (e.g., in one or more directions along the z-axis, as defined in the exemplary orientation of the embodiment illustrated in FIG. 8) in order to maintain the sealed perimeter protecting the internal chamber 2 from the external environment throughout operation of the key switch assembly. In various embodiments, the compression force applied to the O-ring 40 from the respective adjacent surface(s) of the terminal contact housing 100 and the key cylinder housing 200 may be at least substantially evenly distributed throughout the O-ring 40 (e.g., at each angular location along the O-ring 40, as defined about a central axis thereof). For example, in various embodiments, the key switch assembly 1 may be configured such that the set of second snap features defined by the key cylinder housing 200 are configured to engage corresponding first snap features of the terminal contact housing 100 to generate a compression force that acts on the O-ring 40 to cause the O-ring 40 to exhibit an O-ring squeeze of at least approximately between 5% and 30% (e.g., between 15% and 20%). Further, in various embodiments, the compression force acting on the O-ring 40 that is generated as a result of the positive snap connections defined by key switch assembly 1 may cause the O-ring 40 to exhibit an O-ring stretch of at least approximately between 2% and 7% (e.g., between 4% and 6%). Further still, in various embodiments, the compression force acting on the O-ring 40 as a result of the positive snap connections being stablished within the internal chamber 2 of the exemplary key switch assembly 1 may cause the O-ring 40 to exhibit a gland fill within the O-ring channel 204 of at least approximately between 50% and 90% (e.g., between 65% and 75%).

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A key switch assembly comprising:
a key cylinder assembly comprising a key cylinder housing;
a terminal contact assembly comprising a terminal contact housing, the terminal contact assembly being configured for attachment to the key cylinder assembly via one or more engagement of the terminal contact housing with the key cylinder housing, the one or more engagement being defined at least in part by one or more positive snap connection at which a first snap feature of the terminal contact housing is physically engaged with a corresponding second snap feature of the key cylinder housing to at least partially secure the terminal contact housing relative to the key cylinder housing;
wherein the one or more positive snap connection is defined within an internal chamber of the key switch assembly such that the one or more positive snap connection is physically inaccessible from an exterior of the key switch assembly when the key switch assembly is in an assembled configuration.

2. The key switch assembly of claim 1, wherein each of the one or more first snap features comprises a male snap feature that protrudes from one or more interior surfaces defined by the terminal contact housing, and wherein each of the one or more second snap features comprises a female snap feature configured for receiving a corresponding one of the one or more first snap features to facilitate the one or more positive snap connection, wherein each of the one or more second snap features is arranged about an interior sidewall surface of the key cylinder housing.

3. The key switch assembly of claim 1, wherein the one or more positive snap connection comprises a plurality of positive snap connections.

4. The key switch assembly of claim 3, wherein the plurality of positive snap connections comprises at least three positive snap connections.

5. The key switch assembly of claim 1, wherein the at least three positive snap connections are at least substantially evenly distributed about a central axis defined by the key cylinder housing.

6. The key switch assembly of claim 1, wherein each of the one or more second snap features is a female snap feature comprising a pair of retention arms that each extend away from an interior sidewall surface defined by the key cylinder housing, the pair of retention arms being laterally spaced apart from one another so as to define a lateral gap therebetween within which the second snap feature is configured to receive the corresponding first snap feature of the one or more first snap features.

7. The key switch assembly of claim 1, wherein each of the one or more first snap features is a male snap feature comprising at least one protrusion arm having a snap head provided at a distal end of the protrusion element, where each of the at least one protrusion arms protrudes from an internal base surface of the terminal contact housing in an at least substantially perpendicular direction relative to the internal base surface, each snap head being configured to facilitate a positive snap action between the first snap feature and the second snap feature.

8. The key switch assembly of claim 7, wherein the snap head of each protrusion arm is defined at least in part by an angled surface configured to engage at least a portion of the corresponding second snap feature and enable a movement of the first snap feature relative to the corresponding second snap feature in a connecting direction towards a locked position.

9. The key switch assembly of claim 7, wherein the snap head of each of the two protrusions elements defines a flange that extends from a distal end of a respective shaft at an at least substantially right angle to define an engagement surface configured for physical engagement with at least a portion of the corresponding second snap feature.

10. The key switch assembly of claim 1, wherein the one or more positive snap connections are configured to arrange the key cylinder housing relative to the terminal contact housing such that a compression force is applied to an O-ring disposed between at least a portion of the terminal contact housing and at least a portion of the key cylinder housing, wherein the compression force is sufficiently large to cause the O-ring to embody an at least substantially air-tight seal between the at least a portion of the terminal contact housing and the at least a portion of the key cylinder housing.

11. A method comprising:
providing:
a key cylinder assembly comprising a key cylinder housing;
a terminal contact assembly comprising a terminal contact housing, the terminal contact assembly being configured for attachment to the key cylinder assembly via one or more engagement of the terminal contact housing with the key cylinder housing; and
assembling a key switch assembly by causing the one or more engagement of the terminal contact housing with the key cylinder housing, the one or more engagement being defined at least in part by one or more positive snap connection at which a first snap feature of the terminal contact housing is physically engaged with a corresponding second snap feature of the key cylinder housing to at least partially secure the terminal contact housing relative to the key cylinder housing;
wherein the one or more positive snap connection is defined within an internal chamber of the key switch assembly such that the one or more positive snap connection is physically inaccessible from an exterior of the key switch assembly when the key switch assembly is in an assembled configuration.

12. The method of claim 11, wherein each of the one or more first snap features comprises a male snap feature that protrudes from one or more interior surfaces defined by the terminal contact housing, and wherein each of the one or more second snap features comprises a female snap feature configured for receiving a corresponding one of the one or more first snap features to facilitate the one or more positive snap connection, wherein each of the one or more second snap features is arranged about an interior sidewall surface of the key cylinder housing.

13. The method of claim 11, wherein the one or more positive snap connection comprises a plurality of positive snap connections.

14. The method of claim 11, wherein the plurality of positive snap connections comprises at least three positive snap connections.

15. The method of claim 11, wherein the at least three positive snap connections are at least substantially evenly distributed about a central axis defined by the key cylinder housing.

16. The method of claim 11, wherein each of the one or more second snap features is a female snap feature comprising a pair of retention arms that each extend away from an interior sidewall surface defined by the key cylinder housing, the pair of retention arms being laterally spaced apart from one another so as to define a lateral gap therebetween within which the second snap feature is configured to receive the corresponding first snap feature of the one or more first snap features.

17. The method of claim 11, wherein each of the one or more first snap features is a male snap feature comprising at least one protrusion arm having a snap head provided at a distal end of the protrusion element, where each of the at least one protrusion arms protrudes from an internal base surface of the terminal contact housing in an at least substantially perpendicular direction relative to the internal base surface, each snap head being configured to facilitate a positive snap action between the first snap feature and the second snap feature.

18. The method of claim 17, wherein the snap head of each protrusion arm is defined at least in part by an angled surface configured to engage at least a portion of the corresponding second snap feature and enable a movement of the first snap feature relative to the corresponding second snap feature in a connecting direction towards a locked position.

19. The method of claim 17, wherein the snap head of each of the two protrusions elements defines a flange that extends from a distal end of a respective shaft at an at least substantially right angle to define an engagement surface configured for physical engagement with at least a portion of the corresponding second snap feature.

20. The method of claim 11, wherein the one or more positive snap connections are configured to arrange the key cylinder housing relative to the terminal contact housing such that a compression force is applied to an O-ring disposed between at least a portion of the terminal contact housing and at least a portion of the key cylinder housing, wherein the compression force is sufficiently large to cause the O-ring to embody an at least substantially air-tight seal between the at least a portion of the terminal contact housing and the at least a portion of the key cylinder housing.
